(19) United States
(12) Patent Application Publication
(10) Pub. No.: US 2025/0006172 A1
(43) Pub. Date: Jan. 2, 2025

(54) SPEECH AND VIRTUAL OBJECT GENERATION METHOD AND DEVICE

(71) Applicant: Lenovo (Beijing) Limited, Beijing (CN)

(72) Inventors: Sifan MA, Beijing (CN); Zeqing ZHAO, Beijing (CN)

(21) Appl. No.: 18/746,767

(22) Filed: Jun. 18, 2024

(30) Foreign Application Priority Data
Jun. 30, 2023 (CN) 202310798631.1

(51) Int. Cl. G10L 13/027; G06T 13/20; G06T 13/40; G06V 10/764; G06V 10/774; G06V 20/70; G10L 13/04; G10L 13/08

(52) U.S. Cl. CPC G10L 13/027; G06T 13/205; G06T 13/40; G06V 10/764; G06V 10/774; G06V 20/70; G10L 13/04; G10L 13/08

(57) ABSTRACT

A speech generation method includes: obtaining an object image of a virtual object; determining target sound category characteristics corresponding to the virtual object based on the object image; obtaining text information, the text information being used to describe speech content that needs to be output by the virtual object; and generating speech data that conforms to the target sound category characteristics based on the text information and the target sound category characteristics.

### CROSS-REFERENCES TO RELATED APPLICATION

This application claims priority to Chinese Patent Application No. 202310798631.1 filed on Jun. 30, 2023, the entire content of which is incorporated herein by reference.

### FIELD OF TECHNOLOGY

The present disclosure relates to the field of data processing technology and, more specifically, to a speech and virtual object generation method and device.

### BACKGROUND

In virtual scenes such as the ones in metaverse, used by virtual hosts, and in virtual reality, corresponding virtual objects can be generated based on user needs.

In some virtual scenes, while outputting virtual objects, it is also necessary to output the speeches generated for the virtual objects. At present, the speeches generated for virtual objects are generally dubbing input by users or fixed-tone speeches, making the output speech inconsistent with the images of the virtual objects.

### SUMMARY

One aspect of this disclosure provides a speech generation method. The method includes obtaining an object image of a virtual object; determining target sound category characteristics corresponding to the virtual object based on the object image; obtaining text information, the text information being used to describe speech content that needs to be output by the virtual object; and generating speech data that conforms to the target sound category characteristics based on the text information and the target sound category characteristics.

Another aspect of the present disclosure provides a virtual object generation method. The method includes obtaining an object image used to construct the virtual object; determining target sound category characteristics corresponding to the virtual object based on the object image; and constructing the virtual object associated with the target sound category characteristics based on the object image.

Another aspect of the present disclosure provides a speech generation device. The device includes an image acquisition unit, a characteristics determination unit, a text acquisition unit, and a speech generation unit. The image acquisition unit is configured to obtain an object image of a virtual object. The characteristics determination unit is configured to determine target sound category characteristics corresponding to the virtual object based on the object image. The text acquisition unit is configured to obtain text information, the text information being used to describe speech content that needs to be output by the virtual object. The speech generation unit is configured to generate speech data that conforms to the target sound category characteristics based on the text information and the target sound category characteristics.

Another aspect of the present disclosure provides a virtual object generation device. The device includes an image acquisition unit, a characteristics determination unit, and object construction unit. The image acquisition unit is configured to obtain an object image used to construct the virtual object. The characteristics determination unit is configured to determine target sound category characteristics corresponding to the virtual object based on the object image. The object construction unit is configured to construct the virtual object associated with the target sound category characteristics based on the object image.

Another aspect of the present disclosure provides a non-transitory computer-readable storage medium containing computer-executable instructions for, when executed by one or more processors, performing a speech generation method. The method includes obtaining an object image of a virtual object; determining target sound category characteristics corresponding to the virtual object based on the object image; obtaining text information, the text information being used to describe speech content that needs to be output by the virtual object; and generating speech data that conforms to the target sound category characteristics based on the text information and the target sound category characteristics.

Another aspect of the present disclosure provides a non-transitory computer-readable storage medium containing computer-executable instructions for, when executed by one or more processors, performing a virtual object generation method. The method includes obtaining an object image used to construct the virtual object; determining target sound category characteristics corresponding to the virtual object based on the object image; and constructing the virtual object associated with the target sound category characteristics based on the object image.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of a speech generation method according to an embodiment of the present disclosure.

FIG. 2 is another flowchart of the speech generation method according to an embodiment of the present disclosure.

FIG. 3 is a diagram of an object training classification model according to an embodiment of the present disclosure.

FIG. 4 is a flowchart of training an object classification model according to an embodiment of the present disclosure.

FIG. 5 is another diagram of the object training classification model according to an embodiment of the present disclosure.

FIG. 6 is a schematic diagram of the object training classification model in an application scenario according to an embodiment of the present disclosure.

FIG. 7 is a schematic diagram of a principle of generating speech data based on text information and sound category features of virtual objects according to an embodiment of the present disclosure.

FIG. 8 is a flowchart of a virtual object generation method according to an embodiment of the present disclosure.

FIG. 9 is a schematic structural diagram of a speech generation device according to an embodiment of the present disclosure.

FIG. 10 is a schematic structural diagram of a virtual object generation device according to an embodiment of the present disclosure.

FIG. 11 is a schematic structural diagram of an electronic device according to an embodiment of the present disclosure.

### DETAILED DESCRIPTION

The technical solutions provided in the embodiments of the present disclosure can be applied to scenarios in which virtual objects are generated and speech is generated and output for the virtual objects in virtual scenes such as Metaverse, virtual hosts, and virtual reality.

Taking the virtual host as an example, systems consistent with embodiments of the present disclosure may construct a two-dimensional or three-dimensional virtual character, and the speech signal can be output based on the host's content as the speech content broadcast by the virtual character such that the virtual character can be used to produce online broadcast or recording. For example, on some e-commerce platforms or some live news platforms, the generated virtual characters can be used as hosts, and by outputting speech, the virtual characters can introduce the products of the e-commerce platform or broadcast news.

Depending on the application scenario, the virtual objects that need to be generated and the speech content that needs to be output are different, which is not limited by descriptions of the embodiments of the present disclosure.

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

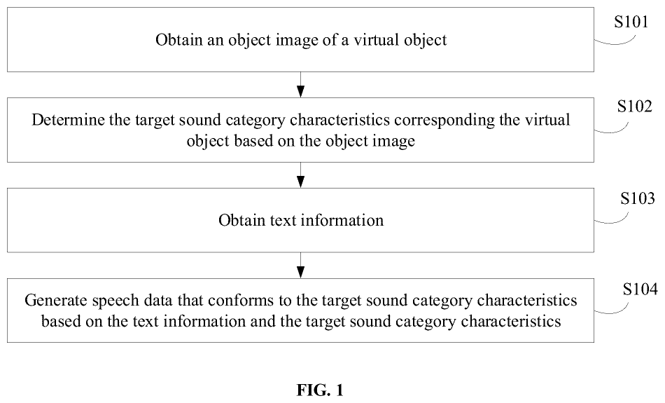

FIG. 1 is a flowchart of a speech generation method according to an embodiment of the present disclosure. The update method can be applied to any electronic device. The electronic device may be an independent electronic device, such as a server, or the electronic device may be a node device in a cloud platform, a cluster system, or a distributed system. The speech generation method will be described in detail below.

101, obtaining an object image of a virtual object.

In some embodiments, the object image may include an image of the virtual object and the object image may reflect the external performance characteristics of the virtual object, such as the object type of the virtual object, the externally expressed personality characteristics, the object image, etc. Take the virtual object as a virtual character as an example, the object image can reflect the gender, age, clothing characteristics, facial features and other object characteristics of the virtual character. These characteristics can reflect the character characteristics of the object, such as personality and emotion.

In some embodiments, the object image of the virtual object may be the object image of the virtual object that has been constructed. When the object image is obtained, the virtual object may have been output to the virtual scene, or may be to-be-output to the virtual scene, which is not limited in the embodiments of the present disclosure. For example, if a three-dimensional virtual object is constructed and output in a virtual scene, the object image of the three-dimensional virtual object can be obtained. In another example, in a live broadcast or metaverse scene, a three-dimensional virtual character can be constructed, and an image of the constructed three-dimensional virtual character can be obtained.

The object image of the virtual object may also be the object image used to construct the virtual object in the virtual scene. Take constructing a virtual three-dimensional character as an example, the object image can be a face image used to construct a virtual three-dimensional task or an object image containing a face. Based on this, in the embodiments of the present disclosure, the speech data that the virtual object needs to output can be synchronously generated during the process of constructing the virtual object.

102, determining the target sound category characteristics corresponding to the virtual object based on the object image.

The target sound category characteristics may be used to characterize the sound type or sound category output by the virtual object. Based on the specific scene, the division of the sound categories can also be different.

Since sounds of different sound categories can differ in characteristics such as timbre, pitch, and loudness, the target sound category characteristics can reflect the characteristics of the sounds output by the virtual object in terms of timbre, pitch, and loudness.

It should be understood that since the object image of a virtual object can reflect the appearance characteristics of the virtual object, and the appearance of the virtual object can be different, the types of sounds that the virtual object has or is suitable for can also be different. Therefore, the target sound category characteristics of the virtual object can be determined by combining the object image and the virtual object.

Take a three-dimensional virtual character that needs to output in a virtual scene as an example. Considering that in real life, the speech types of users of different genders, ages, heights and appearance are very different, depending on the gender, age, height, appearance, etc. of the virtual character, the type of speech corresponding to the virtual character will also be different.

For example, for a taller man, his voice is generally deeper, louder, and more powerful. For a slender man, although his voice is generally deep, but the loudness of his speech may be relatively moderate. For a woman, her voice is gentler, her speaking speed is relatively slow, and the loudness of her speech is moderate.

Similarly, for virtual characters, the sound category characteristics corresponding to the external characteristics of the virtual characters can be determined by combining the object images of the virtual tasks.

It should be understood that after the target sound category characteristics of the virtual object is determined, if the virtual object to be output in the virtual scene does not change, there is no need to repeatedly determine the target sound category characteristics of the virtual object.

Of course, if the facial expression or emotion of the same virtual object is changing, after the virtual object or the expression of the virtual object changes, operation of determining the target sound category of the virtual object can be performed based on requirements to reflect such changes.

103, obtaining text information.

The text information may be used to describe the speech content that needs to be output by the virtual object. That is, the text information may be information in the form of text corresponding to the speech signal output by the virtual object in the virtual scene.

For example, if the virtual object is to broadcast a piece of news, the text information may be the text information of the news broadcast by the virtual object.

The text information may be generated in advance or input by the user based on the virtual scene and the content that the virtual object needs to output. The present disclosure does not limit the method of obtaining the text information.

104, generating speech data that conforms to the target sound category characteristics based on the text information and the target sound category characteristics.

For example, by combining the characteristics of the target sound category, the text information may be converted into a speech signal with the characteristics of the target sound category.

There are many specific implementation methods of combining text information to generate speech data that conforms to the characteristics of the target sound category, which is not limited by the descriptions of the embodiments of the present disclosure.

In the present disclosure, when generating the speech data for a virtual object, the target sound category characteristics of the virtual object are taken into consideration such that the speech data generated for the virtual object is more consistent with the image of the virtual object.

It should be understood that after the speech data is generated, in the present disclosure, the speech data can also be output to the virtual scene such that while the virtual object is presented in the virtual scene, the speech data suitable for the target sound category characteristics of the virtual object can also be synchronously output.

For example, when the operation of this embodiment is completed using an electronic device that controls or outputs a virtual scene, the speech signal may be directly output to the virtual scene. In another example, when the speech data is generated by an electronic device other than the electronic device that outputs the virtual scene, the speech data may be sent to the target electronic device that outputs the virtual scene such that the speech data can be output to the virtual scene through the target electronic device.

Consistent with the present disclosure, the target sound category characteristics of the virtual object can be determined based on the object image of the virtual object such that the determined target sound category characteristics are consistent with image characteristics of the virtual object, and can accurately reflect the suitable sound characteristics of the virtual object. In addition, in the embodiments of the present disclosure, the text information corresponding to the speech content output by the virtual object to generate the speech data can be combined with the characteristics of the target sound category of the virtual object. In this way, a more reasonable speech signals for the virtual object can be generated such that the sound characteristics of the speech signals output by the virtual object I in the virtual scene are more consistent with the identity of image of the virtual object.

There are many specific implementation methods for determining the target sound category characteristics of the virtual object based on the object image of the virtual object, which is not limited in the embodiments of the present disclosure.

The speech generation method of the present disclosure will be described in detail below by taking a method of determining that target sound category characteristics of a virtual object as an example.

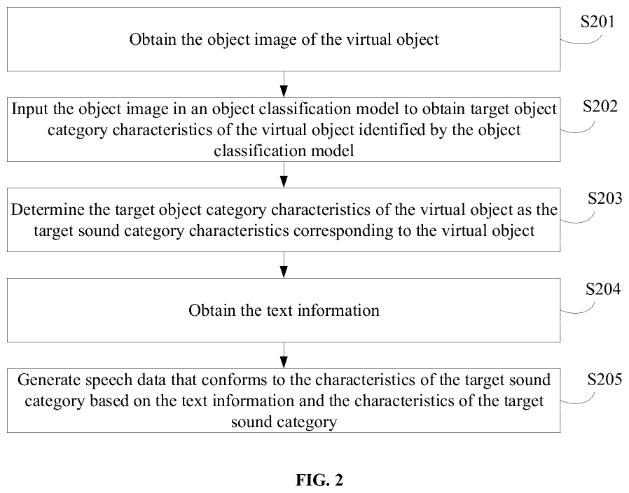

FIG. 2 is another flowchart of the speech generation method according to an embodiment of the present disclosure. The method will be described in detail below.

201, obtaining the object image of the virtual object.

202, inputting the object image in an object classification model to obtain target object category characteristics of the virtual object identified by the object classification model.

The object classification model may be a classification model that classifies objects based on object images of objects (such as physical objects or virtual objects).

Take the object as a user as an example (the same applies to virtual characters). By using the image of the user, the object classification model can be used to identify the identity of the user.

Take the object as a vehicle as an example (e.g., the virtual object is a virtual vehicle). By using the image of the vehicle, the object classification model can be used to identify the vehicle category of the vehicle.

Of course, the above are examples of the present disclosure. For different objects or virtual objects, the object classification model will also classify the objects differently, which is not limited in the embodiments of the present disclosure.

The target object category characteristics can be identified by the object classification model based on the object image of the virtual object and can characterize the virtual object classification result. The classification result may be a specific classification or an object category. Correspondingly, the object category or classification to which the virtual object belongs may be reflected through the target object category characteristics.

If the virtual object is a virtual character, the object classification model may be based on the object image of the virtual character, and the determined the classification result may be the character type category of the virtual task or the different characters it belongs to.

If the virtual object is an object other than a virtual character, the object category identified by the object classification model may be one of a plurality of categories set in advance that the virtual object may belong. For example, an object classification model of animal species may identify the animal category to which the object belongs.

It should be understood that before outputting the object classification result, the object classification model may first extract the object category characteristics of the object (which can be a virtual object) in the object image, and then determine the object classification result based on the object category characteristics. In the present disclosure, only the extraction of the object category characteristics identified in the object image by the object classification model is needed.

For example, considering that the final output of the object classification model is the classification result, in the present disclosure, the object category characteristics output by the previous layer of the output layer in the object classification model may be obtained. For example, if the object classification model is a convolutional neural network model, the characteristics output by the convolutional layer closest to the output layer can be extracted and used as the object category characteristics. Of course, this is only an example, if the object classification model is another network model or other type of model, then only the characteristics extracted by the last layer before the output layer in the object classification model may be needed.

For ease of distinction, the object category characteristics identified by the object classification model from the object image of the virtual object can be referred to as target object category characteristics.

203, determining the target object category characteristics of the virtual object as the target sound category characteristics corresponding to the virtual object.

Based on the foregoing description, it can be seen that the sound category characteristics of the virtual object are closely related to the appearance characteristics presented by the virtual object, and the target object category characteristics of the virtual object actually reflect the category characteristics of the appearance of the virtual object. Therefore, the target object category characteristics of the virtual object can be used as the sound category characteristics characterizing the sound category of the virtual object.

For ease of distinction, in the present disclosure, the sound category characteristics of the virtual object are referred to as target sound category characteristics.

204, obtaining the text information.

In some embodiments, the text information may be used to describe the speech content that needs to be output by the virtual object.

205, generating speech data that conforms to the characteristics of the target sound category based on the text information and the characteristics of the target sound category.

For the processes at 204 and 205, reference can be made to the relevant description in the foregoing embodiments, which will not be repeated here.

In the present disclosure, the object category characteristics of the virtual object may be analyzed with the help of the object image of the virtual object. Considering that the object category characteristics can reflect the category characteristics related to the appearance of the virtual object, the sound category characteristics of the virtual object will also be closely related to the appearance of the virtual object. Therefore, the target object category characteristics determined based on the object image of the virtual object can be used as the sound category characteristics of the virtual object. In this way, not only the object image of the virtual object can be used to more accurately determine the sound category characteristics of the virtual object, but the sound category characteristics of the virtual object can also be determined more efficiently with the help of the image classification technology. In this way, speech data that conforms to the sound category characteristics of the virtual object can be generated more reasonably.

In the present disclosure, the object classification model may be based on an existing classification model. Take the virtual object as a virtual character as an example, the object classification model may use a user classification model that classifies users based on images.

To improve the accuracy of the object classification model to determine the classification result, in the present disclosure, an image classification model may be trained in advance using multiple samples labeled with object identifiers, and the trained image classification model may be used as the object classification model. In some embodiments, the object identifier may be the object category, object name or object unique identifier. For example, multiple image samples labeled with object identifiers can be used to train a convolutional neural network model using a supervised training method, and the trained convolutional neural network model can be determined as the object classification model.

In some embodiments, considering that the object classification model is based on object images of virtual objects, if only a general object classification model based on image classification is directly used to extract object category characteristics, the extracted object category characteristics may be more included to the category characteristics of the object in the image, and there may be some gaps with the category characteristics of the object in sound.

Based on this, in order to use the object classification model to more accurately extract characteristics that reflect the sound category of the virtual object from the object image of the virtual object such that the target object category characteristics and the virtual object's sound category characteristics can be as consistent as possible. In the present disclosure, the object classification model may use a first image sample in at least one sample group, and the object category characteristics identified by the object classification model from the first sample image and the sound category characteristics identified by the sound classification model from the first sound sample corresponding to the first image sample may be the same as the training target that can be obtained by training.

In some embodiments, the sample group may include a first image sample and a first sound sample belonging to the same object. The first sound sample corresponding to the first image sample may be a first sound sample that belongs to the same sample group or the same object as the first image sample.

In some embodiments, the sound classification model may be any general sound classification model or a pre-trained sound classification model. For example, a sound classification model may be obtained by training multiple sound samples labeled with object identifiers. For example, multiple sound samples labeled with object identifiers may be used to train a neural network model or an open-source sound classification model to obtain the trained sound classification model, which is not limited in the embodiments of the present disclosure.

Based on this, by continuously training the object classification model, the object category characteristics identified by the object classification model from the first image sample can be substantially close to the sound category characteristics identified by the sound classification model from the first sound sample that belongs to the same sample group as the first image sample. Based on this, after training the object classification model using this method, the target object category characteristics extracted from the virtual object using the object classification model can accurately reflect the sound category characteristics of the virtual object such that the target object category characteristics can be determined as the target sound category characteristics of the virtual object.

Further, considering that there are differences in the speeches of different objects, in order to be able to propose individual differences, in the process of training the object classification model, in addition to ensuring that the object category characteristics extracted are as consistent as possible with the sound category characteristics extracted by the sound classification model, the object category characteristics also need to fully and accurately reflect the characteristics of different individual objects. Based on this, in the present disclosure, the training objectives for training the object classification model may also include that the precited object information of the first image sample determined using the object classification model is consistent with the actual object identifier labeled by the sample group to which the first image sample belongs.

In some embodiments, the predicted object information of the first image sample determined by the object classification model may also be the classification result of the object predicted by the object classification model based on the first image sample, such as the object included (or belongs to) the first image sample, or the object category to which the object in the first image sample belongs, etc. For the description of the classification result, reference can be made to the relevant description in the foregoing embodiments, which is not limited in the embodiments of the present disclosure.

In some embodiments, the object identifier labeled by the sample group may be used to indicate the object from which the sample group originates or the category to which the object from which the sample group originates belongs.

Correspondingly, if the predicted object information matched the actual object identifier labeled by the sample group corresponding to the first image sample, it may indicate that the prediction accuracy of the object classification model meets the requirements, and the object information predicted by the object classification model is consistent with the object information actually corresponding to the first image sample.

Based on this, in the present disclosure, a supervised training method may be used to train the object classification model, and continuously optimize the object classification model in combination with the above training objectives to complete the training of the object classification model.

It should be understood that during the process of training the object classification model, the sound classification model may be trained simultaneously. In some embodiments, in order to ensure that the object category characteristics identified by the object classification model can more accurately and more prominently reflect the user's characteristics in sound category, during the process of training the object classification model, the internal parameters of the sound classification model may be kept unchanged, and only the parameters of the object classification model may be adjusted.

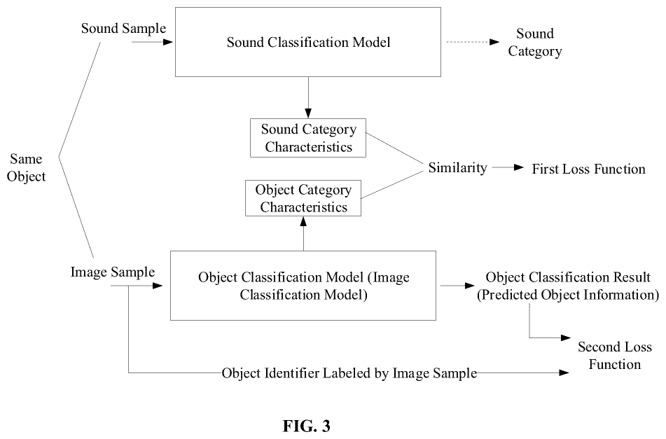

FIG. 3 is a diagram of an object training classification model according to an embodiment of the present disclosure.

It can be seen from FIG. 3 that in the present disclosure, the sample group for training the object classification model includes the first image sample and the first sound sample, and the sample group is labeled with an actual object identifier. Each time, the first image sample and the first sound sample from the same sample group need to be input to the object classification model and the sound classification model respectively.

Based on this, for each sample group, there is a need to determine the similarity between the object category characteristics identified by the object classification model from the first image sample and the sound category characteristics identified by the sound classification model from the first sound sample.

When calculating the function value of the first loss function based on the similarity, there is also a need to calculate the function value of the second loss function by combining the object prediction information determined by the object classification model based on the first image sample and the object identifier labeled by the sample group. Based on this, in the present disclosure, the function value of the first loss function and the function value of the second loss function need to be combined to determine whether the training object is met. In this way, in the process of training the object classification model, the two objectives of the object category characteristics and sound category characteristics being as identical as possible and the object prediction information being consistent with the object identifier labeled by the sample group can be met.

For ease of understanding, with reference to FIG. 3, a specific implementation method of training an object classification model is taken as an example in the following description.

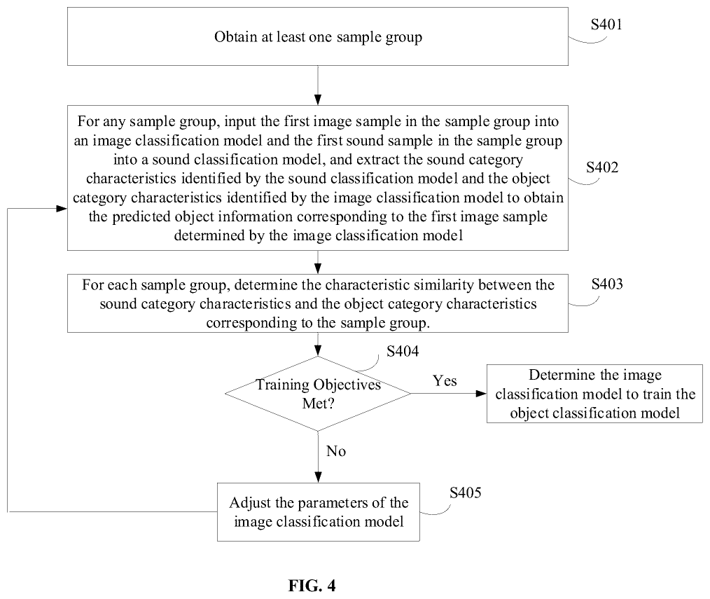

FIG. 4 is a flowchart of training an object classification model according to an embodiment of the present disclosure. The method will be described in detail below.

401, obtaining at least one sample group.

As described above, each sample group may include the first image sample and the first sound sample belonging to the same object, and the sample group may be labeled with the actual object identifier corresponding to the object to which the sample group actually belongs.

402, for any sample group, inputting the first image sample in the sample group into an image classification model and the first sound sample in the sample group into a sound classification model, and extracting the sound category characteristics identified by the sound classification model and the object category characteristics identified by the image classification model to obtain the predicted object information corresponding to the first image sample determined by the image classification model.

In the present disclosure, training may be performed on the basis of the image classification model and the image classification model trained using the embodiment of FIG. 4 can be determined as the object classification model. The image classification model can identify the predicted object information of the image sample (or object image) including the object, which is substantially the object classification result described in the foregoing embodiments. The predicted' object information can indicate the object to which the image sample (or object image) belongs or the object category of the object.

In some embodiments, the object category characteristics may be extracted from the output layer of the image classification model and may be used to determine characteristics of the predicted object information. For example, if an image classification model includes multiple convolutional layers and an output layer that outputs the predicted object information, the characteristics output by the last convolutional layer can be extracted, the characteristics being the object category characteristics.

Similarly, the sound category characteristics may be extracted from the characteristics identified by the sound classification model before the output layer of the sound classification model and have not yet been input to the output layer for predicting the sound category.

In the present disclosure, during the process of training the object classification model, the parameters within the sound classification model may be fixed such that there is no need to pay attention to the sound category output by the sound classification model.

In addition, in order for the trained object classification model to accurately identify the object classification result from the object image, in the present disclosure, there is a need to obtain the predicted object information corresponding to the first image sample determined by the image classification model for subsequent comparison with the actual object identifier labeled by the sample group to which the first image sample belongs.

403, for each sample group, determining the characteristic similarity between the sound category characteristics and the object category characteristics corresponding to the sample group.

Different methods can be used to determine the similarity of the characteristics. For example, the cosine similarity between the sound category characteristics and the object category characteristics can be calculated, or the Euclidean distance can be calculated. The present disclosure does not limit the method to determine the similarity of the characteristics, which can be set based on actual needs.

404, determining whether the training objectives are met based on the characteristic similarity, predicted object information and actual object identifier corresponding to each sample group, if so, determining the image classification model as the trained object classification model; otherwise, proceed to the process at 405.

As described above, the training objectives include that the object category characteristics identified by the object classification model (which can be considered as an image classification model here) from the first image sample are consistent with the sound category characteristics identified by the sound classification model from the first sound sample corresponding to the first image sample, and that the predicted object information of the first image sample identified by the object classification model (which can be considered as an image classification model here) is consistent with the actual object identifier labeled by the sample group to which the first image sample belongs.

In practical applications, different methods can be used to determine whether the training objectives are met based on the characteristic similarity, predicted object information, and actual object identifier corresponding to each sample group.

For example, refer to FIG. 3, the first loss function value may be calculated by combining the characteristic similarity corresponding to each sample group and a preset first loss function, where the higher the similarity of characteristics corresponding to each group of sample groups, the smaller the value of the first loss function will be. At the same time, the second loss function value may be calculated by combining whether the predicted object information corresponding to each sample group is consistent with the actual object identifier, and the second loss function, where the more predicted object information corresponding to each sample group matches the actual object identifier, the smaller the value of the second loss function will be. Based on this, if the first loss function value and the second loss function value converge, or the comprehensive loss function value determined by combining the first loss function value and the second loss function value converges, or the training iteration reaches a target number, the training objectives can be considered as met.

Of course, the embodiment shown in FIG. 3 is only an example. When the training objectives are determined, different methods can be used to determine whether the training objectives are met by combining the characteristic similarity, predicted object information, and actual object identifier corresponding to each sample group, which is not limited in the embodiments of the present disclosure.

405, adjusting the parameters of the image classification model, and returning to the operation of extracting the sound category characteristics identified by the sound classification model and the object category characteristics identified by the image classification model in the process at 402.

In practical applications, the process may be directly returned to the process at 402 each time the parameters of the image classification model are adjusted. Of course, the image samples or sound samples in the image classification model and the object classification model may also be input once without repeated input. In this way, the obtained sound category characteristics and the object category characteristics can be directly extracted after adjusting the parameters of the image classification model.

It should be understood that in the training process shown in FIG. 4, the image classification model and the sound classification model may use existing classification models, such as some general or open-source image classification models and sound classification models.

Considering that in practical applications, there are relatively few sample pairs composed of image samples and sound samples belonging to the same object, in order to enable to trained object classification model to extract the object category characteristics from the object image to express the characteristics of the sound category as accurately as possible by using a relatively limited number of sample groups, there is a need to ensure the classification accuracy of the image classification model and sound classification model used in training the object classification model.

Based on this, in some embodiments, before performing the process at 402, the sound classification model may also be obtained by first training using a plurality of second sound samples labeled with object identifiers, and the image classification model may be obtained by training using a plurality of second image samples labeled with object identifiers. The specific training method can be any supervised training method, which is not limited in the embodiments of the present disclosure.

For example, a plurality of second sound samples labeled with object identifier may be used to train a neural network model or an initial sound classification model to obtain a trained sound classification model.

In another example, a plurality of second image samples labeled with object identifier may be used to train a neural network model or an open-source image classification model to obtain a trained image classification model.

In some embodiments, the plurality of second sound samples may originate from different objects, and the object identifiers labeled by the second sound samples may represent the object to which the second sound samples belongs or the object category of the object.

In some embodiments, the plurality of second sound samples may be completely different from the plurality of first sound samples, or the plurality of second sound samples may include part or all of the first sound samples. In addition, in general, the number of second sound samples may be greater than the number of first sound samples.

In some embodiments, the object identifiers of the second image samples may characterize the object to which the second image samples belongs or the object category of the object.

In some embodiments, the second image samples may be completely different from the first image samples, or the first image samples may be part of the second image samples. In general, the number of second image samples may be greater than the number of first image samples.

After using the second sound sample to train to obtain the sound classification model and using the second image sample to train to obtain the image classification model, multiple sample groups can be used to further train the image classification model by using the sound classification model to obtain the object classification model.

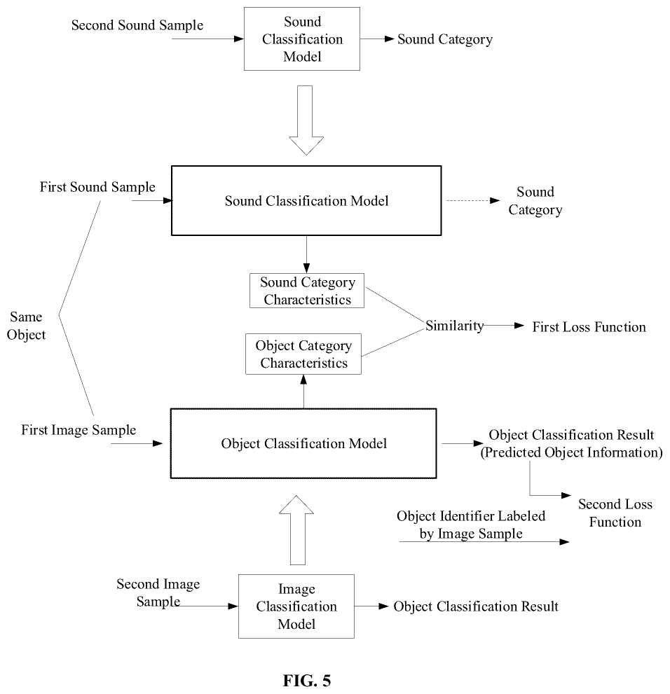

For ease of understanding, refer to FIG. 5. FIG. 5 is another diagram of the object training classification model according to an embodiment of the present disclosure. Comparing FIG. 3 and FIG. 5, it can be seen that in the process of training the object classification model, the sound classification model used is the sound classification model trained in advance using the second sound sample. In addition, before training the object classification model, the first image sample is used to train the image classification model in advance. Subsequently, the image classification model is used as the to-be-trained object classification model, and multiple sample groups are used to train the image classification model using the method shown in FIG. 3 until an object classification model that meets the training objectives is obtained.

For ease of understanding, the following is a simple explanation based on an application scenario, which takes a three-dimensional virtual character that needs to output in a virtual scene as an example. In this case, in order to be able to output the character in the virtual scene, a speech suitable for the character can be output based on the gender and appearance of the character. Therefore, the object classification model for identifying the character category characteristics of the virtual character in combination with the character image of the virtual character (the character image includes at least a face image of the virtual object) may be trained in advance.

In this application scenario, for the process of training the object classification model, reference can be made to FIG. 6.

FIG. 6 is a schematic diagram of the object training classification model in an application scenario according to an embodiment of the present disclosure. In this application scenario, the training process of the sound classification model is similar to the process shown in the foregoing embodiments in FIG. 3 to FIG. 5.

The image classification model may select the face classification model. Before using the sample group to train the face classification model, a plurality of second face image samples labeled with user identities may be used to train the face classification model that can accurately identify the user or user category to which the face image belongs.

Based on this, the face classification model trained using the second face image samples can be used as the to-be-trained object classification model.

Each sample group for training the face classification model and the sound classification model as the object classification model may include a first sound sample and a first face image sample belonging to the same user (that is, originating from the same user). Based on this, the training objective for training the face classification model as the object classification model needs to ensure that the face category characteristics identified by the face classification model from the first face image sample and the sound category characteristics (that is, the speaker's speech category characteristics) identified by the sound classification model from the first sound sample are consistent. Further, the training objective for training the face classification model as the object classification model needs to ensure that the user identified by the face classification model as belonging to the first face image sample matches the user labeled with the first face image sample.

Consistent with the present disclosure, the character image of the virtual character in the virtual scene (or the face image used to construct the virtual character) can be obtained, the trained face classification model can be used to identify the user category characteristics of the character image, and the user category characteristics can be determined as the sound category characteristics of the virtual character. Based on this, if there is a need to generate a speech for the virtual character in the virtual scene, text information can be used to synthesize the character's speech with the sound category characteristics such that the speech can be output to the virtual scene. In this way, the virtual character in the presented virtual scene can produce sounds that match the virtual character's image.

Different methods can be used to generate speech data that conforms to the characteristics of the target sound category based on text information, which is not limited in the embodiments of the present disclosure.

In some embodiments, speech data may be generated using speech synthesis models. More specifically, based on the text information and target sound category characteristics, a speech synthesis model may be used construct speech data to obtain the speech data with the target sound category characteristics.

For example, after the text information is vector-encoded, the vector encoding of the text information and the target sound category characteristics may be input to the speech synthesis model to obtain the speech data output by the speech synthesis model.

In some embodiments, the speech synthesis model may be a model that synthesizes speech signals based on a given text information. For example, the speech synthesis model may be a general speech synthesis model, an open-source speech synthesis model, or a neural network model trained as needed.

Further, in order for the speech synthesis model to more accurately synthesize speech data with the target sound category characteristics, in the present disclosure, at least one pair of information samples labeled with speech signals may be used to first train the speech synthesis model. The pair of information samples may include text information samples and sound category characteristics samples that match each other. For example, any supervised training method may be used to train the speech synthesis model such that through continuous training, the speech data generated by the speech synthesis model based on the pair of information samples can be consistent with the speech signal labeled by the information sample group. The specific training process is not limited in the present disclosure.

In the present disclosure, different structures of the speech synthesis model may be used. For example, the speech synthesis model may be the natural language synthesis model FastSpeech2, which is not limited in the embodiments of the present disclosure.

For ease of understanding, the following description takes a specific structural form as an example to describe the process of synthesizing speech data using a speech synthesis model.

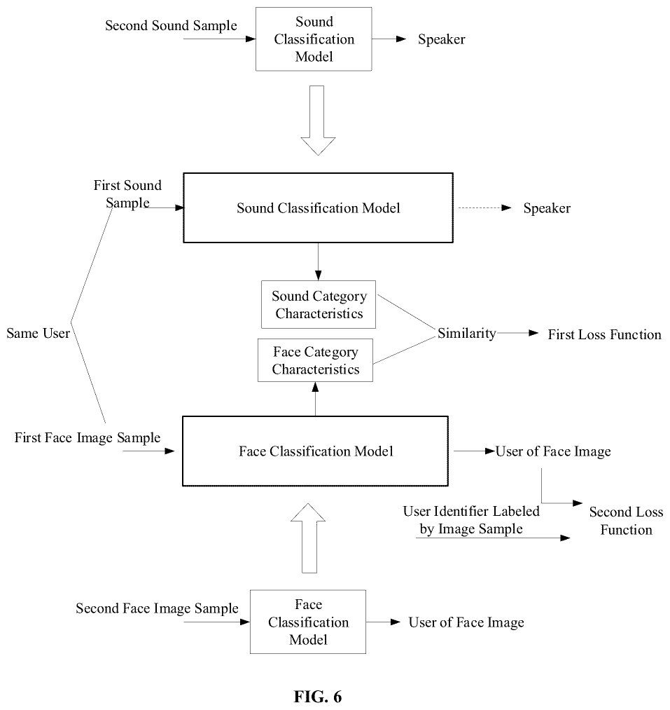

FIG. 7 is a schematic diagram of a principle of generating speech data based on text information and sound category features of virtual objects according to an embodiment of the present disclosure. As shown in FIG. 7, after the text information is converted into a text embedded vector, the position encoding vector is determined to be encoded together with the text embedded vector, and then input to a transformation adaptation layer together with the sound category characteristics. The transformation adaptation layer may be used to predict pauses between phonemes, and may include predictions of pitch and volume to better grasp sound characteristics. Based on this, the characteristics output by the adaptation layer can be transformed into text position encoding and then decoded to obtain the decoded speech data.

Of course, FIG. 7 is only a simple example. In practical applications, depending on the speech synthesis model, the process of synthesizing speech data based on text information and sound category characteristics will also be different, which is not limited in the embodiments of the present disclosure.

In the present disclosure, before constructing or outputting a virtual object, the sound category characteristics of the virtual object may be determined first, and then speech data may be generated based on the sound category characteristics of the virtual object based on actual needs.

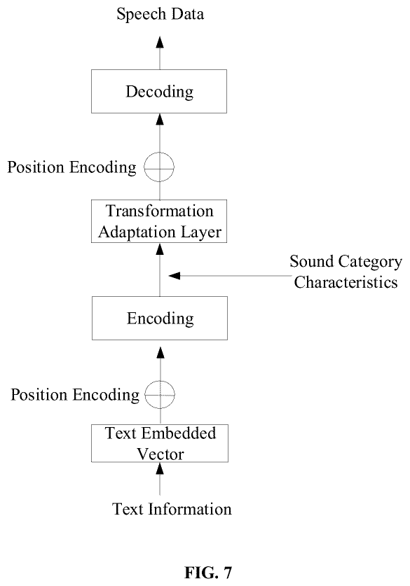

FIG. 8 is a flowchart of a virtual object generation method according to an embodiment of the present disclosure. The method will be described in detail below.

801, obtaining the object image used to construct the virtual object.

In some embodiments, the virtual object may be a three-dimensional virtual object, or the virtual object may be a two-dimensional virtual object, which is not limited in the embodiments of the present disclosure.

In some embodiments, the object image to construct the virtual object may also be the object image required to synthesize the virtual object.

Take the virtual object as a three-dimensional virtual character as an example, the object image used to construct the virtual object can be a face image.

Of course, for other virtual scenes, the object images required to construct the virtual object will also be different depending on the virtual object, which is not limited in the embodiments of the present disclosure.

802, determining the target sound category characteristics corresponding to the virtual object based on the object image.

For example, the object image may be input into the object classification model to obtain the target object category characteristics of the virtual object identified by the object classification model, and the target object category characteristics of the virtual object may be determined as the target sound category characteristics corresponding to the virtual object. For a detailed description of the object classification model, reference can be made to the relevant description in the foregoing speech generation method embodiments.

The process at 802 is consistent with the process of determining the target sound category characteristics of the virtual object in the foregoing speech generation method embodiments. For details, reference can be made to the relevant description in the foregoing embodiments, which will not be repeated here.

803, constructing a virtual object associated with the target sound category characteristics based on the object image.

The process of constructing virtual objects based on the object images may use virtual reality technology and other related technologies for generating objects in virtual scenes. The present disclosure does not limit the process of constructing a virtual object.

Different from conventional technology of synthesizing virtual objects, in the present disclosure, the synthesized virtual object is associated with the target sound category characteristics of the virtual object. Based on the target sound category characteristics, the characteristics of the sound produced by the virtual object can be reflected.

Consistent with the present disclosure, the target sound category characteristics of the virtual object can be determined based on the object image used to construct the virtual object such that the determined target sound category characteristics are consistent with the appearance of the virtual object, and can accurately reflect the sound characteristics suitable for the virtual object. Based on this, the virtual object can be associated with the target sound category characteristics, which is beneficial to reasonably generating sound suitable for the virtual object.

It should be understood that in the embodiment of FIG. 8, after the virtual object is constructed, text information may also be obtained, and the text information may be used to describe the speech content that needs to be output by the virtual object. For example, when there is a need to simulate a virtual object emitting sound in a virtual scene, the configuration or user-input text information corresponding to the sound information to be emitted by the virtual object can be obtained.

Therefore, based on the text information, speech data with the target sound category characteristics can be generated for the virtual three-dimensional object. For the process of generating speech data with the target sound category characteristics for the virtual object, reference can be made to the relevant description in the foregoing embodiments, which will not be repeated here.

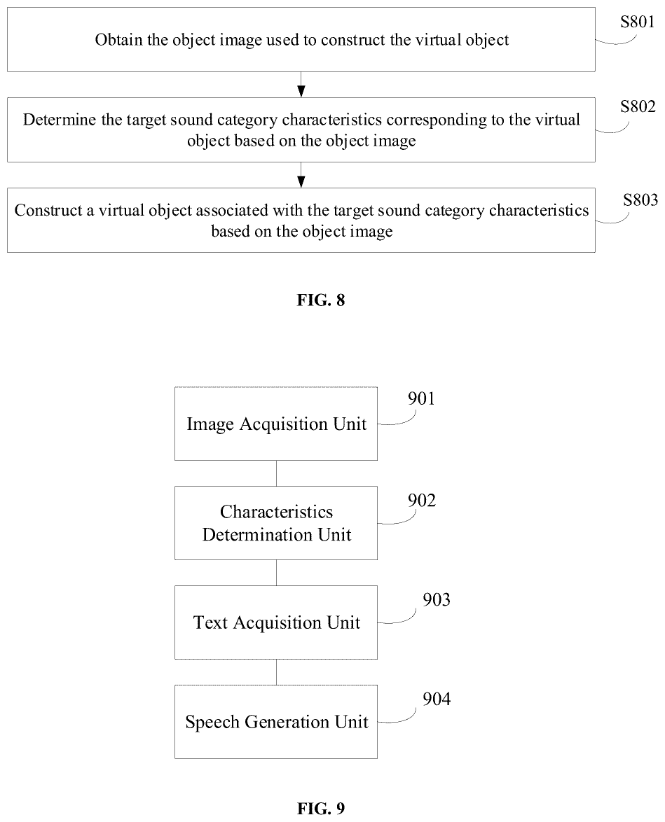

Corresponding to the first speech generation method provided by the embodiments of the present disclosure, an embodiment of the present disclosure further provides a speech generation device. FIG. 9 is a schematic structural diagram of a speech generation device according to an embodiment of the present disclosure.

As shown in FIG. 9, the speech generation device includes an image acquisition unit 901, a characteristics determination unit 902, a text acquisition unit 903, and a speech generation unit 904.

In some embodiments, the image acquisition unit 901 may be configured to obtain the object image of the virtual object.

In some embodiments, the characteristics determination unit 902 may be configured to determine the target sound category characteristics corresponding to the virtual object based on the object image.

In some embodiments, the text acquisition unit 903 may be configured to obtain text information, the text information being used to describe the speech content that needs to be output by the virtual object.

In some embodiments, the speech generation unit 904 may be configured to generate speech data that conforms to the target sound category characteristics based on the text information and the target sound category characteristics.

In some embodiments, the characteristics determination unit 902 may include an object characteristics determination unit and a sound characteristics determination unit. The object characteristics determination unit may be configured to input the object image into an object classification model and obtain the target object category characteristics of the virtual object identified by the object classification model. The sound characteristics determination unit may be configured to determine the target object category characteristics of the virtual object as the target sound category characteristics corresponding to the virtual object.

In some embodiments, the object classification model may use a first image sample in at least one sample group, and the object category characteristics identified by the object classification model from the first sample image and the sound category characteristics identified by the sound classification model from the first sound sample corresponding to the first image sample may be the same as the training target that can be obtained by training.

In some embodiments, the sample group may include a first image sample and a first sound sample belonging to the same object.

In some embodiments, the sample group used by the object classification model in the training of the object characteristics determination unit may be labeled with actual object identifiers.

In some embodiments, the training objective of the object classification model may include that the predicted object information of the first image sample determined by the object classification model is consistent with the object identifier labeled by the sample group to which the first image sample belongs.

The device may also include a model training unit for training the object classification model. The training method may include: obtaining at least one sample group; for any sample group, inputting the first image sample in the sample group into an image classification model and the first sound sample in the sample group into a sound classification model, and extracting the sound category characteristics identified by the sound classification model and the object category characteristics identified by the image classification model to obtain the predicted object information corresponding to the first image sample determined by the image classification model; if it is determined that the training objectives are not met based on the characteristic similarity, predicted object information and actual object identifier corresponding to each sample group, adjusting the parameters of the image classification model, and returning to the operation of extracting the sound category characteristics identified by the sound classification model and the object category characteristics identified by the image classification model until the training objectives are met, the image classification model being used to determine a trained object classification model.

In some embodiments, the speech generation unit 904 may include a speech generation subunit. The speech generation subunit may be configured to use a speech synthesis model to construct speech data based on the text information and target sound category characteristics, and obtain speech data with the target sound category characteristics.

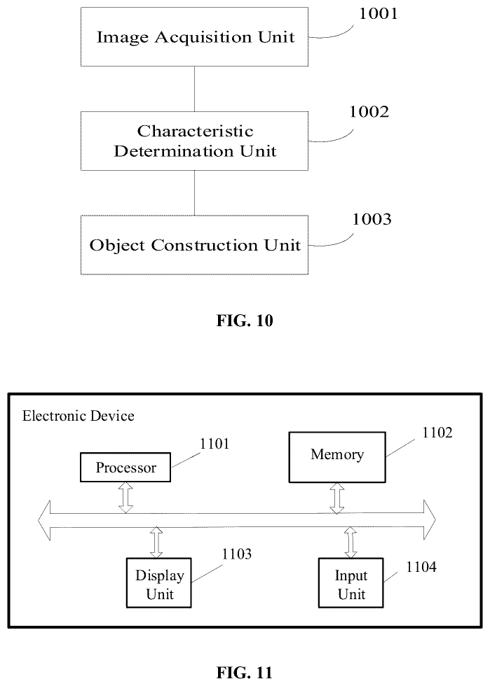

Corresponding to the virtual object generation method provided by the embodiments of the present disclosure, an embodiment of the present disclosure further provides a virtual object generation device. FIG. 10 is a schematic structural diagram of a virtual object generation device according to an embodiment of the present disclosure.

As shown in FIG. 10, the virtual object generation device includes an image acquisition unit 1001, a characteristics determination unit 1002, and an object construction unit 1003.

In some embodiments, the image acquisition unit 1001 may be configured to obtain the object image used to construct the virtual object.

In some embodiments, the characteristics determination unit 1002 may be configured to determine the target sound category characteristics corresponding to the virtual object based on the object image.

In some embodiments, the object construction unit 1003 may be configured to construct the virtual object associated with the target sound category characteristics based on the object image.

In some embodiments, the object generation device may be further configured to obtain text information, the text information being used to describe the speech content that needs to be output by the virtual object; and generating the speech data having the target sound category characteristics for the virtual object based on the text information.

The present disclosure also provides an electronic device. FIG. 11 is a schematic structural diagram of an electronic device according to an embodiment of the present disclosure. The electronic device can be any type of electronic device. As shown in FIG. 6, the electronic device at least includes a processor 1101 and a memory 1102. The processor 1101 is configured to perform the speech generation method or virtual object generation method of any of the previously described embodiments. The memory 1102 is configured to store programs needed for the processor 1101 to perform operations.

It should be understood that the electronic device may also include a display unit 1103 and an input unit 1104.

Of course, the electronic device may also have more or fewer components than in FIG. 11, which is not limited in the embodiments of the present disclosure.

The present disclosure also provides a computer-readable storage medium. The computer-readable storage medium stores at least one instruction, at least one program, code set or instruction set. The at least one instruction, the at least one program, the code set or instruction set is loaded and executed by a processor to perform the update method in any one of the above-described embodiments.

The present disclosure also provides a computer program. The computer program includes computer instructions. The computer instructions are stored in a computer-readable storage medium. When the computer program runs on an electronic device, the computer program is used to perform the update method in any one of the above-described embodiments.

The terms such as “first,” “second,” “third,” “fourth,” and the like in the specification and in the claims, if any, are used for distinguishing similar elements and not necessarily for describing a particular sequential or chronological order. It can be understood that the terms so used are interchangeable under appropriate circumstances such that the embodiments of the present disclosure herein are capable of operation in sequences other than those illustrated or described herein.

It should be noted that each embodiment in this specification is described in a progressive manner, and each embodiment focuses on the differences from other embodiments. For the same and similar parts in each embodiment, reference can be made to each other. At the same time, the features described in various embodiments in this specification may be replaced or combined with each other, such that those skilled in the art can implement or use the present disclosure. As for the device-type embodiments, because they are basically similar to the method embodiments, the description thereof is relatively simple. For details of related parts, reference can be made to the description of the method embodiments.

Further, it should also be noted that in this specification, relational terms such as first and second etc. are only used to distinguish one entity or operation from another, and do not necessarily require or imply that any such actual relationship or order of these entities or operations exists. The terms “includes,” “comprises” or any other variation thereof are intended to cover a non-exclusive inclusion such that a process, method, article, or apparatus comprising a set of elements includes not only those elements, but also includes elements not expressly listed. or also includes elements inherent in such a process, method, article, or apparatus. Without further limitations, an element defined by the phrase “comprising a . . . ” does not preclude the presence of additional identical elements in the process, method, article, or apparatus that includes the element.

The above description of the disclosed embodiments is provided to enable those skilled in the art to make or use the present disclosure. Various modifications to these embodiments will be readily apparent to those skilled in the art, and the general principles defined herein may be implemented in other embodiments without departing from the spirit or scope of the present disclosure. Therefore, the present disclosure will not be limited to the embodiments shown herein, but is to be accorded the widest scope consistent with the principles and novel features disclosed herein.

The embodiments disclosed herein are merely examples. Other applications, advantages, alternations, or modifications of, or equivalents to the disclosed embodiments are obvious to a person skilled in the art and are intended to be encompassed within the scope of the present disclosure.

What is claimed is:

1. A speech generation method comprising:
obtaining an object image of a virtual object;
determining target sound category characteristics corresponding to the virtual object based on the object image;
obtaining text information, the text information being used to describe speech content that needs to be output by the virtual object; and
generating speech data that conforms to the target sound category characteristics based on the text information and the target sound category characteristics.

2. The method of claim 1, wherein determining the target sound category characteristics corresponding to the virtual object based on the object image includes:
inputting the object image into an object classification model to obtain target object category characteristics of the virtual object identified by the object classification model; and
determining the target object category characteristics of the virtual object as the target sound category characteristics corresponding to the virtual object.

3. The method of claim 2, wherein:
the object classification model is obtained by training using a first image sample in at least a sample group, and object category characteristics identified by the object classification model from the first sample image are the same as sound category characteristics identified by a sound classification model from a first sound sample corresponding to the first image sample as training objectives, the sample group including the first image sample and the first sound sample belonging to the same object.

4. The method of claim 3, wherein:
the sample group is labeled with an actual object identifier, and the training objectives also includes that predicted object information of the first image sample determined by using the object classification model is consistent with the actual object identifier labeled by the sample group to which the first image sample belongs.

5. The method of claim 4, wherein training the object classification model includes:
obtaining at least one sample groups;
for each sample group, inputting the first image sample in the sample group into an image classification model and the first sound sample in the sample group into the sound classification model, and extracting the sound category characteristics identified by the sound classification model and the object category characteristics identified by the image classification model to obtain the predicted object information corresponding to the first image sample determined by the image classification model; and
in response to the training objectives not being met based on characteristic similarity, the predicted object information and the actual object identifier corresponding to each sample group, adjusting parameters of the image classification model, and returning to extraction of the sound category characteristics identified by the sound classification model and the object category characteristics identified by the image classification model until the training objectives are met, the image classification model being used to determine a trained object classification model.

6. The method of claim 1, wherein generating the speech data that conforms to the target sound category characteristics based on the text information and the target sound category characteristics includes:
using a speech synthesis model to construct the speech data to obtain the speech data with the target sound category characteristics based on the text information and the target sound category characteristics.

7. A virtual object generation method comprising:
obtaining an object image used to construct the virtual object;
determining target sound category characteristics corresponding to the virtual object based on the object image; and
constructing the virtual object associated with the target sound category characteristics based on the object image.

8. The method of claim 7 further comprising:
obtaining text information, the text information being used to describe speech content that needs to be output by the virtual object; and
generating speech data with the target sound category characteristics for the virtual object based on the text information.

9. A non-transitory computer-readable storage medium containing computer-executable instructions for, when executed by one or more processors, performing a speech generation method, the method comprising:
obtaining an object image of a virtual object;
determining target sound category characteristics corresponding to the virtual object based on the object image;
obtaining text information, the text information being used to describe speech content that needs to be output by the virtual object; and
generating speech data that conforms to the target sound category characteristics based on the text information and the target sound category characteristics.

10. The non-transitory computer-readable storage medium of claim 9, wherein determining the target sound category characteristics corresponding to the virtual object based on the object image includes:
inputting the object image into an object classification model to obtain target object category characteristics of the virtual object identified by the object classification model; and
determining the target object category characteristics of the virtual object as the target sound category characteristics corresponding to the virtual object.

11. The non-transitory computer-readable storage medium of claim 10, wherein:
the object classification model is obtained by training using a first image sample in at least a sample group, and object category characteristics identified by the object classification model from the first sample image are the same as sound category characteristics identified by a sound classification model from a first sound sample corresponding to the first image sample as training objectives, the sample group including the first image sample and the first sound sample belonging to the same object.

12. The non-transitory computer-readable storage medium of claim 11, wherein:
the sample group is labeled with an actual object identifier, and
the training objectives also includes that predicted object information of the first image sample determined by using the object classification model is consistent with the actual object identifier labeled by the sample group to which the first image sample belongs.

13. The non-transitory computer-readable storage medium of claim 12, wherein training the object classification model includes:
obtaining at least one sample groups;
for each sample group, inputting the first image sample in the sample group into an image classification model and the first sound sample in the sample group into the sound classification model, and extracting the sound category characteristics identified by the sound classification model and the object category characteristics identified by the image classification model to obtain the predicted object information corresponding to the first image sample determined by the image classification model; and
in response to the training objectives not being met based on characteristic similarity, the predicted object information and the actual object identifier corresponding to each sample group, adjusting parameters of the image classification model, and returning to extraction of the sound category characteristics identified by the sound classification model and the object category characteristics identified by the image classification model until the training objectives are met, the image classification model being used to determine a trained object classification model.

14. The non-transitory computer-readable storage medium of claim 9, wherein generating the speech data that conforms to the target sound category characteristics based on the text information and the target sound category characteristics includes:
using a speech synthesis model to construct the speech data to obtain the speech data with the target sound category characteristics based on the text information and the target sound category characteristics.
